(19) United States
(12) Patent Application Publication
(10) Pub. No.: US 2026/0356107 A1
(43) Pub. Date: Nov. 12, 2026

(54) IMAGE FORMING APPARATUS

(71) Applicant: CANON KABUSHIKI KAISHA, Tokyo (JP)

(72) Inventor: SHUICHI TAKENAKA, Chiba (JP)

(21) Appl. No.: 19/639,602

(22) Filed: Apr. 6, 2026

(30) Foreign Application Priority Data
May 7, 2025 (JP) 2025-077172

(51) Int. Cl. B41J 13/00; B41J 11/00; B41J 13/02; B41J 13/03

(52) U.S. Cl. CPC B41J 13/0036; B41J 11/0095; B41J 13/025; B41J 13/03

(57) ABSTRACT

An image forming apparatus includes an ink head, a conveyance portion including a first conveyance member configured to nip and convey the recording medium by a pair of rotating members disposed upstream of the ink head in a conveyance direction of the recording medium, a first sensor configured to detect the recording medium, a second sensor configured to detect the recording medium, and a controller configured to perform control to separate the pair of rotating members when it is determined that a conveyance failure has occurred in a predetermined region including an image forming region by the ink head based on a detection result of the first sensor, and perform control not to separate the pair of rotating members when it is determined that a conveyance failure has occurred in a region different from the predetermined region based on a detection result of the second sensor.

### BACKGROUND

### Field of the Technology

The present disclosure relates to an image forming apparatus that conveys a recording medium to form an image.

### Description of the Related Art

In an image forming apparatus for commercial printing having a large machine body, a conveyance path of a recording sheet as a recording medium is often long, and removing each remaining recording sheet at the time of occurrence of sheet conveyance failure has a large influence on downtime. When a conveyance failure occurs, a recording sheet at a position that is not affected by the conveyance failure is retracted to a temporary retraction destination according to an image forming state, and residual sheet retraction control is required to shorten downtime as much as possible.

On the other hand, an inkjet type image forming apparatus that ejects ink onto a recording sheet to form an image includes a recording head unit including an inkjet head that ejects ink in an image forming portion. The inkjet head of the recording head unit is a precision portion constituted by a precision mechanism, and is disposed close to the recording surface of the recording medium to perform image forming process. In a case where a conveyance failure of the recording sheet occurs and appropriate retraction control of the residual sheet is not performed, the recording sheet deformed due to the failure may enter and come into contact with the inkjet head, which may cause a failure in the inkjet head.

Therefore, an inkjet type commercial printing machine is required to perform retraction control that enables protection of an inkjet head unit that is a precision portion when a conveyance failure occurs. As a technique related to the retraction control in a case where a conveyance failure of the recording sheet occurs as described above, a technique has been proposed in which a conveying roller having a separation mechanism that performs conveyance control is separated, and the recording sheet is caused to remain and is controlled not to move any more. By doing so, the recording sheet is kept at the position at the time of occurrence of conveyance failure, and control is performed so as not to cause additional failure (Japanese Patent Application Laid-Open No. 2006-39336).

However, in the retraction control described in the above prior art, the conveying roller having the separation mechanism is always separated at the time of occurrence of the conveyance failure, and thus the recording sheet remains at the position at the time of occurrence of the failure. In a large commercial printing machine having a long conveyance path, it takes time and effort to remove the remaining recording sheets one by one, and the downtime increases.

### SUMMARY

An image forming apparatus disclosed below to solve the above problem includes an ink head configured to eject ink onto a recording medium to form an image, a conveyance portion including a first conveyance member configured to nip and convey the recording medium by a pair of rotating members disposed upstream of the ink head in a conveyance direction of the recording medium, a separation portion configured to separate the pair of rotating members from each other, a first sensor configured to detect the recording medium conveyed along a conveyance path, a second sensor configured to detect the recording medium at a position different from a position of the first sensor, and a controller configured to perform control to separate the pair of rotating members by the separation portion when it is determined that a conveyance failure has occurred in a predetermined region including an image forming region by the ink head based on a detection result of the first sensor, and perform control not to separate the pair of rotating members by the separation portion when it is determined that a conveyance failure has occurred in a region different from the predetermined region based on a detection result of the second sensor.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are configuration diagrams of an image forming apparatus;

FIGS. 2A and 2B are arrangement diagrams of conveyance sensors included in the image forming apparatus;

FIGS. 3A and 3B are detailed hardware configuration diagrams of a separation mechanism;

FIGS. 4A and 4B are schematic diagrams of conveyance position adjustment;

FIG. 5 is a hardware block diagram of the image forming apparatus;

FIG. 6 is a software block diagram of the image forming apparatus;

FIG. 7 illustrates an image forming apparatus and a conveyance sequence;

FIGS. 8A and 8B illustrate an image forming apparatus and a conveyance sequence;

FIGS. 9A and 9B illustrate an image forming apparatus and a conveyance sequence;

FIG. 10 is a sequence diagram of sheet conveyance process;

FIG. 11 is a sequence diagram of retraction control when a conveyance failure occurs;

FIG. 12 is a flowchart of image forming control;

FIG. 13 is a flowchart of conveyance failure detection control;

FIG. 14 is a flowchart of conveyance control;

FIG. 15 is a flowchart of residual sheet detection control; and

FIG. 16 is a flowchart of separation control.

### DESCRIPTION OF THE EMBODIMENTS

Hereinafter, an image forming apparatus according to an embodiment of the present disclosure will be described. The image forming apparatus according to the present embodiment includes an inkjet head that ejects ink to a printing portion to form an image. In addition, a separation mechanism of a pair of conveying rollers which conveys a sheet which is a recording medium is provided. The pair of conveying rollers is disposed upstream of the inkjet head in the sheet conveyance direction, and when a sheet conveyance failure occurs, whether or not the separation control is performed is switched according to a position on the conveyance path.

When a conveyance failure occurs in the vicinity of the inkjet head, separation control is performed so that the pair of conveying rollers is immediately separated and the recording sheet located upstream of the head remains on the spot. On the other hand, in a case where a conveyance failure occurs at a position other than the vicinity of the inkjet head, the conveying roller is continuously driven in the abutment state without being separated, and the recording sheet not affected by the conveyance failure is retracted to a predetermined temporary retraction destination. Hereinafter, the embodiment will be described in more detail with reference to the drawings.

### Overall Configuration of Image Forming Apparatus

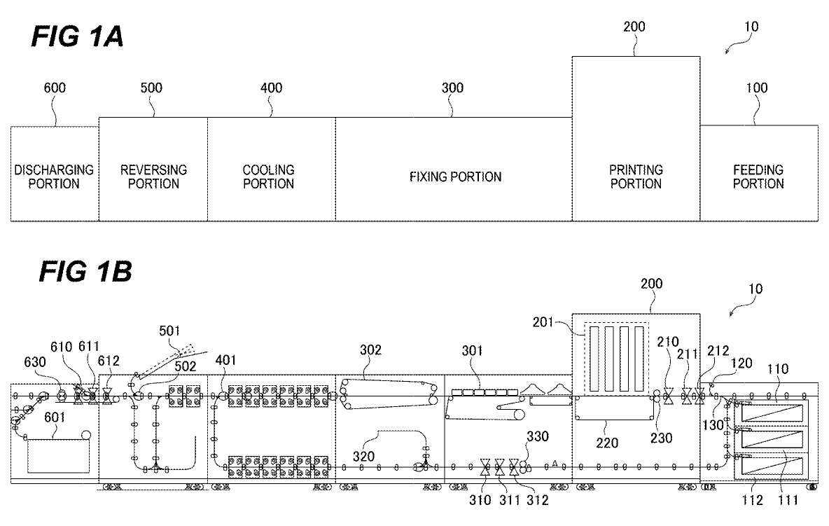

FIGS. 1A and 1B illustrate a configuration of an image forming apparatus 10 according to an embodiment of the present disclosure.

FIG. 1A illustrates a conceptual diagram of each unit constituting the image forming apparatus 10 according to the present embodiment. The image forming apparatus 10 includes six units including a feeding portion 100, a printing portion 200, a fixing portion 300, a cooling portion 400, a reversing portion 500, and a discharging portion 600.

The feeding portion 100 is a unit having a sheet cassette, and as illustrated in FIG. 1B, has three stages of sheet cassettes 110, 111, and 112 for holding various recording sheets which are recording media used for printing process. The feeding portion 100 further includes a first discharge port 120 for temporarily retracting the recording sheet which is not affected by a sheet conveyance failure when the failure occurs, and further includes a conveyance branch 130 (first conveyance branch) for switching a conveyance path for guiding the recording sheet to the discharge port 120 and a conveyance path for guiding the recording sheet to a downstream unit after the printing portion 200. A known conveyance switching flapper-shaped member is disposed in the conveyance branch 130, and the conveyance destination of the recording sheet can be switched by driving the flapper member.

Next, the printing portion 200 is a unit that prints a printed image on a recording sheet, and includes an inkjet head 201 that ejects ink onto the recording sheet conveyed along a conveyance path by a conveyance portion to form an image, as illustrated in FIG. 1B. Furthermore, conveying rollers 210, 211, and 212 including a pair of rollers that conveys a recording sheet to an image forming region by the inkjet head 201 are provided upstream of the inkjet head 201 in the sheet conveyance direction. The pair of rollers of the conveying rollers 210, 211, and 212 can be separated from each other by a separation mechanism (separation portion) to be described later.

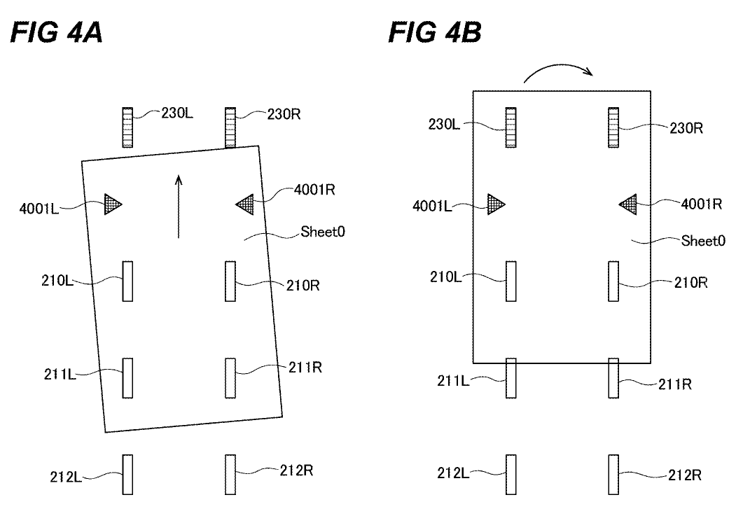

In addition, the printing portion 200 includes a print belt 220 capable of performing high-definition synchronous adjustment of the image forming process of the inkjet head 201 and the recording sheet conveyance process by hardware ASIC control, and an adjustment pinch roller 230 that performs conveyance position adjustment to be described later with reference to FIGS. 4A and 4B.

Next, the fixing portion 300 is a unit that performs fixing control for fixing the image printed by the printing portion 200 to the recording sheet, and fixes the printed image using a plurality of heater units. As illustrated in FIG. 1B, the fixing portion 300 includes a heater belt 301 and a fixing belt 302, and performs ink fixing control by adding, to the recording sheet, heat of which temperature is controlled with high definition by hardware ASIC control. Further, similarly to the feeding portion 100, a second discharge port 320 for temporarily retracting the recording sheet is provided. Further, conveying rollers 310, 311, and 312 having a separation mechanism to be described later, and an adjustment pinch roller 330 are provided, and are used for adjusting the posture of the recording sheet in conveyance control to be described later with reference to FIGS. 4A and 4B.

Next, the cooling portion 400 is a unit that performs temperature control of cooling the recording sheet warmed by the fixing portion 300 and returning the recording sheet to normal temperature, and cools the recording sheet using a plurality of fan units. Furthermore, as illustrated in FIG. 1B, the cooling portion 400 includes a conveyance branch 401 (second conveyance branch) that switches, by a known flapper member, a conveyance path for guiding the recording sheet subjected to the front surface printing to the printing portion 200 again and a conveyance path for guiding the recording sheet to the downstream unit for the image forming process of a duplex printing job. When processing the duplex printing job, the image forming apparatus according to the present embodiment causes the printing portion 200 to convey a recording sheet for front surface printing of the recording sheet, and then switches the conveyance path in the conveyance branch 401 to convey the recording sheet to the fixing portion 300 and the feeding portion 100 again. Thereafter, the recording sheet is guided to the printing portion 200 again, and conveyance control is performed so that image forming for back surface printing is performed. The recording sheet on which the back surface has been printed is conveyed again to the cooling portion 400 via the fixing portion 300, and when the recording sheet reaches the conveyance branch 401, the recording sheet is guided to the downstream unit, and is stacked in the discharging portion 600 via the reversing portion 500 to be described later.

Next, when the recording sheet is stacked on the downstream discharging portion, the reversing portion 500 is a unit that switches back the conveyed sheet to control sheet reversal in order to switch the printing surface on the front surface to the upper surface or the lower surface. As illustrated in FIG. 1B, the reversing portion 500 further includes a third discharge port 501 that can be used as a temporary retraction destination of the recording sheet, and further includes a conveyance branch 502 (third conveyance branch) that switches a conveyance path for guiding the recording sheet to the discharge port 501 and a conveyance path for guiding the recording sheet to a downstream unit with a known flapper member.

The discharging portion 600 is a unit that performs discharge control by stacking printed recording sheets, and includes an discharge stacker 601 as illustrated in FIG. 1B. Further, conveying rollers 610, 611, and 612 having a separation mechanism to be described later and an adjustment pinch roller 630 are provided, and are used for adjusting the posture of the recording sheet immediately before stacking.

### Arrangement of Sheet Conveyance Sensor

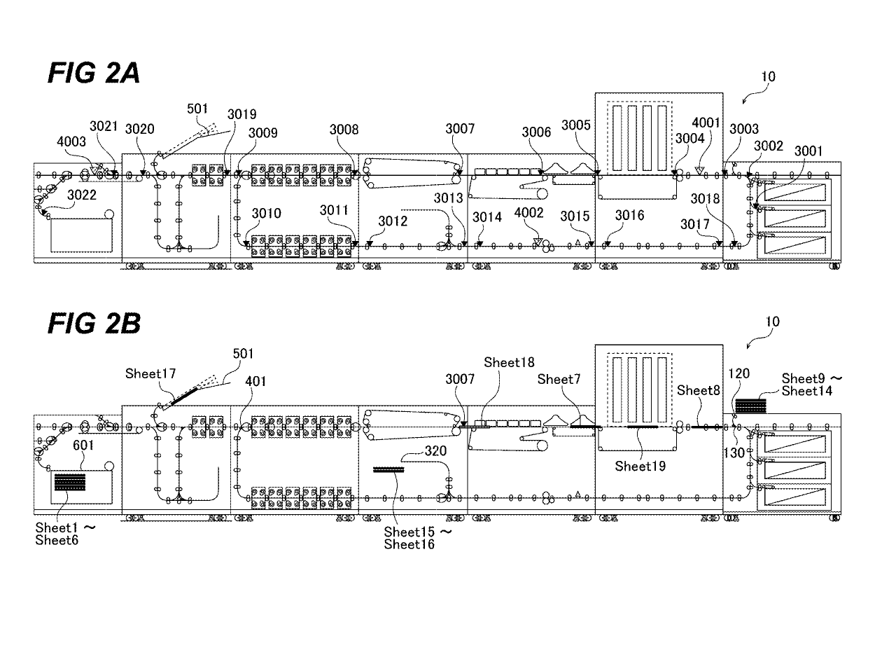

Next, the arrangement of the conveyance sensors included in the image forming apparatus will be described with reference to FIGS. 2A and 2B. The conveyance sensor functions as a retention detection portion that detects a conveyance failure such as retention of the conveyed recording sheet.

In the image forming apparatus according to the present embodiment, as illustrated in FIG. 2A, conveyance sensors 3001 to 3022 are disposed on the conveyance path from the feeding portion 100 to the discharging portion 600. The conveyance sensors 3001 to 3022 can detect the leading edge of the sheet to be conveyed, starts monitoring the sensor passage timing of the recording sheet on the conveyance path when a print job is input to the image forming apparatus, and detects the difference between the assumed time and the actual conveyance time. In a case where the detected conveyance time difference is larger than a predetermined range, it is determined that a sheet conveyance failure such as retention of the sheet has occurred, the occurrence position is specified, it is determined whether or not it is necessary to separate the conveying rollers upstream of the print head 201, and retraction control to be described later is performed.

As illustrated in FIGS. 2A and 2B, the conveyance sensors 3001 to 3003 and 3018 are disposed in the feeding portion 100, and monitor the sensor passage timing of the recording sheet at each position of the feeding portion 100.

The conveyance sensors 3004 and 3005 are disposed at an entrance (upstream of the head) and an exit (downstream of the head) of a conveyance section relating to the inkjet head 201 of the printing portion 200, and the conveyance sensors 3016 and 3017 are disposed at an inlet and an outlet of a conveyance path circulating in the machine and passing through a lower portion for back surface printing, respectively.

The conveyance sensors 3006 and 3007 are disposed at positions on a plurality of heater units in an upper portion of the fixing portion 300, and the conveyance sensors 3012, 3013, 3014, and 3015 are disposed at an inlet, a central portion, and an outlet of a conveyance path circulating in the machine and passing through a lower portion of the fixing portion 300, respectively.

The conveyance sensors 3008, 3009, 3010, and 3011 are disposed in the upper and lower portions of the cooling portion 400, respectively, and are positioned at the entrance and the exit of the conveyance section where the cooling control is performed, and monitor the sensor passage timing of the recording sheet.

The conveyance sensors 3019 and 3020 are disposed on the upper portion of the reversing portion 500 and are positioned at the entrance and the exit of the conveyance section where the reverse control of the conveyed sheet is performed, respectively, and monitor the sensor passage timing of the recording sheet.

The conveyance sensors 3021 and 3022 are disposed in the discharging portion 600 and are positioned at the entrance and the exit of the conveyance section where the discharge stacking control is performed to monitor the sensor passage timing of the recording sheet.

Furthermore, the image forming apparatus 10 according to the present embodiment includes skew detection sensors 4001, 4002, and 4003 each including two sensors on the right and left with respect to the conveyance direction of the recording sheet, and detects the skew state of the recording sheet being conveyed. In a case where the detected skew amount is larger than a predetermined threshold, conveyance position adjustment to be described later with reference to FIGS. 4A and 4B is performed to adjust the conveyance posture of the recording sheet so as not to cause a failure in image forming.

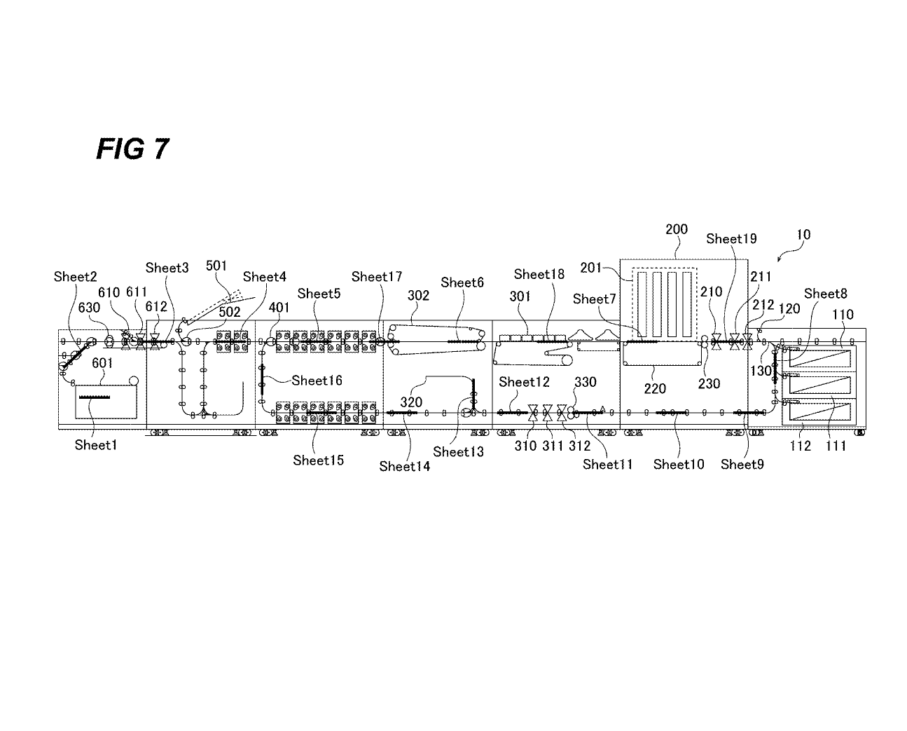

FIG. 2B illustrates a conveyance retraction control result in a case where 19 sheets from Sheet1 to Sheet19 are conveyed in the apparatus and a conveyance failure of Sheet18 is detected by the conveyance sensor 3007 during the image forming process of the duplex printing designation. Here, an outline of the conveyance retraction control of the present embodiment will be described. Sheet18 which is an abnormal sheet, and Sheet7, Sheet19, and Sheet8 located upstream thereof are left as residual sheets since there is no retraction destination on the conveyance path. On the other hand, normal sheets of Sheet1 to Sheet6 on which duplex printing has already been performed when the conveyance failure occurs are discharged to the discharge stacker 601. In addition, control is performed such that Sheet9 to Sheet14 on which only the front surface is printed and the back surface remains blank are discharged to the discharge port 120, Sheet15 and Sheet16 are discharged to the discharge port 320, and Sheet17 is discharged to the discharge port 501. Details of this retraction control will be described later in detail with reference to FIGS. 7 - 9B.

### Configuration of Separation Mechanism

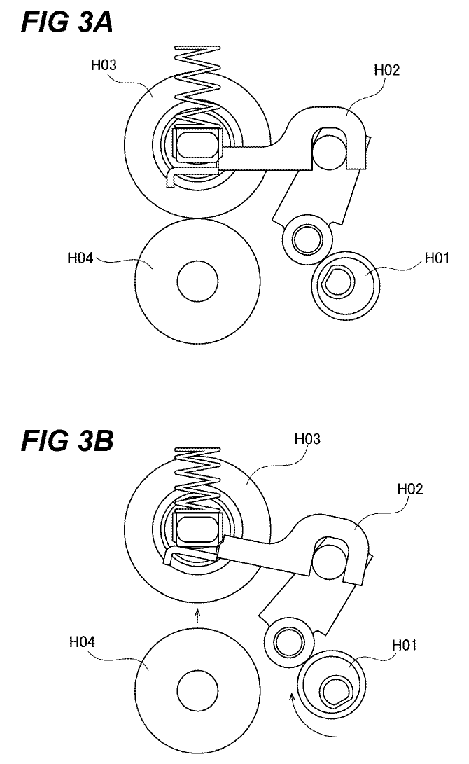

FIGS. 3A and 3B illustrate a separation mechanism for separating the pair of rollers of the conveying rollers 210, 211, 212, 310, 311, 312, 610, 611, and 612 of the present embodiment illustrated in FIG. 1. In FIGS. 3A and 3B, a roller cam H01 is a cam that is rotationally driven by a separation roller (not illustrated) and abuts against a lift arm H02. As illustrated in FIGS. 3A and 3B, when the eccentric roller cam H01 rotates, the outer shape of the eccentric roller cam H01 pushes up the abutted lift arm H02. The lift arm H02 is connected to the driven roller H03, and when the arm is pushed up by the roller cam H01, the arm is driven to lift the driven roller H03 as illustrated in FIG. 3B.

In a normal state, the driven roller H03 is arranged in the state of FIG. 3A, and abuts against the conveying roller H04 at a predetermined nip pressure as a pair. When the recording sheet is conveyed, the recording sheet is pressed by the driven roller H03 and the conveying roller H04 to apply a nip pressure, and rotational driving by the conveying roller H04 is transmitted. When the roller cam H01 rotates by a predetermined half circumference, the arrangement of FIG. 3B is obtained, the driven roller H03 is separated from the conveying roller H04, the nip pressure is released during the conveyance control, the rotational driving of the conveying roller H04 is not transmitted to the recording sheet, and the conveyance can be immediately stopped.

In the retraction control of the present embodiment, when a sheet conveyance failure occurs, the conveying roller H04 corresponding to the conveying rollers 210, 211, and 212 in the upstream portion of the inkjet head 201 is driven and controlled from the abutment state of FIG. 3A to the separated state of FIG. 3B according to the occurrence position. By doing so, the conveyance of the recording sheet is stopped, and the residual sheet is prevented from entering the inkjet head 201.

### Conveyance Position Adjustment

FIGS. 4A and 4B are schematic diagrams of conveyance position adjustment performed by the image forming apparatus 10 according to the present embodiment during sheet conveyance control. The image forming apparatus 10 according to the present embodiment adjusts the conveyance position of the recording sheet on a predetermined conveyance path during conveyance control so that a printed image is correctly printed at a predetermined position on the recording sheet by the inkjet head 201. In the conveyance position adjustment, the skew detection sensors 4001, 4002, and 4003 illustrated in FIG. 2A are used to detect the skew of the recording sheet with respect to the conveyance direction, and the position adjustment according to the skew amount detected using the adjustment pinch rollers 230, 330, and 630 arranged downstream of the conveying rollers 210, 211, 212, 310, 311, 312, 610, 611, and 612 illustrated in FIG. 1B is applied. At this time, the position adjustment is performed in a state where the nip pressure of the recording sheet to be conveyed with respect to the conveying roller is released using the conveying rollers 210, 211, 212, 310, 311, 312, 610, 611, and 612 having the separation mechanism described in FIG. 1.

FIGS. 4A and 4B illustrate a positional relationship between Sheet0, which is a conveyed recording sheet, and the adjustment pinch roller 230 (230L and 230R), the skew detection sensor 4001 (4001L and 4001R), and the conveying rollers 210 (210L and 210R), 211 (211L and 211R), and 212 (212L and 212R) arranged in the printing portion 200 as a positional relationship when the sheet surface is viewed from above with respect to the conveyance direction of the recording sheet. FIG. 4A illustrates a positional relationship when Sheet0 is conveyed from the lower portion to the upper portion of the drawing, and the leading edge of the recording sheet reaches the conveyance position adjustment position.

A pair of left and right conveying rollers 210, 211, and 212 are arranged in the sheet width direction, and the conveying rollers 210L, 210R, 211L, 211R, 212L, and 212R are first in abutment state respectively and convey Sheet0. However, when the leading edge of Sheet0 reaches the adjustment pinch rollers 230L and 230R arranged as a left-right pair of conveying rollers in the sheet width direction, the conveying rollers are separated from each other before the conveyance position adjustment is started. In addition, the skew detection sensors 4001L and 4001R arranged as a left-right pair in the sheet width direction corresponding to the pinch rollers 230L and 230R detect the leading edge of the sheet, respectively, and detect the skew of the recording sheet with respect to the conveyance direction. Then, the driving amount of the adjustment pinch rollers 230L and 230R is adjusted according to the detected skew amount.

In the example of FIG. 4A, since the skew detection sensor 4001R side first detects the leading edge of the sheet and then the skew detection sensor 4001L side detects the leading edge of the sheet, the driving amount of the adjustment pinch roller 230L is made larger than that of the adjustment pinch roller 230R. As a result, a velocity difference is generated between the adjustment pinch rollers 230L and 230R, and Sheet0 is rotated by the movement difference, and skew feeding is corrected as illustrated in FIG. 4B. At this time, since Sheet0 rotates horizontally with respect to the conveyance direction, when the conveying rollers other than the adjustment pinch roller 230 abut on Sheet0, deformation occurs due to the influence of the respective nip pressures. Therefore, as described above, the conveying rollers 210L, 210R, 211L, 211R, 212L, and 212R are separated from each other to prevent Sheet0 from being deformed due to the influence of the skew correction.

Although FIGS. 4A and 4B illustrate the conveyance position adjustment in the printing portion 200, the conveyance position adjustment is similarly performed in the adjustment pinch roller 330, the skew detection sensor 4002, and the conveying rollers 310, 311, and 312 arranged in the fixing portion 300. Furthermore, the adjustment pinch roller 630, the skew detection sensor 4003, and the conveying rollers 610, 611, and 612 arranged in the discharging portion 600 also perform similar conveyance position adjustment. Further, the control of the adjustment pinch rollers 230, 330, and 630 may be performed by an ASIC processor 1010 instead of a CPU 1001. Similarly to the conveying rollers 210, 211, 212, 310, 311, 312, 610, 611, and 612, the adjustment pinch rollers 230, 330, and 630 may be further provided with a separation mechanism. In this case, it is possible to finely adjust the synchronization of the conveyance position adjustment control or to apply emergency separation for avoiding a roller stop delay at the time of occurrence of conveyance failure.

### Hardware Block Diagram of Image Forming Apparatus

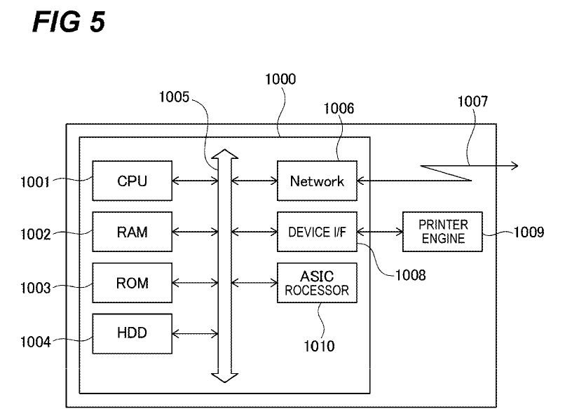

FIG. 5 is a hardware block diagram illustrating a configuration of the image forming apparatus 10 according to the present embodiment. A controller unit 1000 illustrated in FIG. 5 controls input and output of sensor signals and device information. A program in which the processing contents of the present embodiment are described is stored in a ROM 1003 or an HDD 1004 and installed in the image forming apparatus 10. The CPU 1001 reads the program stored in the ROM 1003 or the HDD 1004 into the RAM 1002 and executes the program. Further, the CPU 1001 integrally controls each device connected to a system bus 1005.

The RAM 1002 functions as a main memory and a work memory of the CPU 1001. The ROM 1003 stores a boot program executed when the power is turned ON, and the HDD 1004 stores an operating system and a control program main body of the present apparatus. The HDD 1004 is also used for the purpose of temporarily or long-term holding large-capacity data.

A network 1006 is connected to a local area network 1007 and performs inputting and outputting data and device information to and from the outside. Alternatively, the program can be installed in the ROM 1003 or the HDD 1004 via the network 1006.

A device I/F 1008 is an interface portion with a printer engine 1009, and inputs and outputs signals for operating and referring to various motors, sensors, the inkjet head 201, and the like connected to the printer engine 1009. The printer engine 1009 is an inkjet type output device that conveys a recording sheet by load control from the controller unit 1000 and controls the inkjet head 201 to output an image on the recording sheet.

The ASIC processor 1010 is a hardware processor capable of controlling specific control at high speed and high definition by a dedicated hardware circuit. In the present embodiment, the ASIC processor 1010 is used for controlling the print belt 220 of the printing portion 200 and controlling the heater belt 301 and the fixing belt 302 of the fixing portion 300, which require precise control.

### Software Block Diagram of Image Forming Apparatus

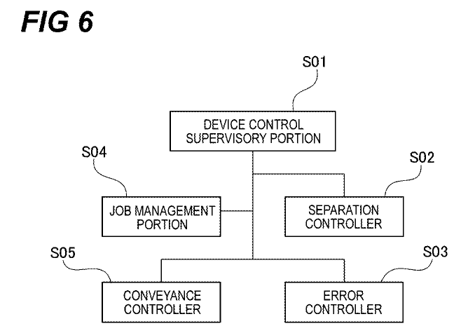

FIG. 6 is a software block diagram in the controller unit 1000 of the image forming apparatus 10 according to the present embodiment. Each software module illustrated in FIG. 6 is stored in the HDD 1004 as a program, loaded into the RAM 1002, and executed by the CPU 1001 in conjunction with the ASIC processor 1010.

The device control supervisory portion S01 controls each of the following separation controller S02, error controller S03, job management portion S04, and conveyance controller S05 in the present embodiment, and integrally controls processing from the start to the end of the image forming process.

The separation controller S02 is in charge of adjustment of the conveyance posture of the recording sheet and separation control for retraction control at the time of occurrence of conveyance failure to be described later with reference to FIGS. 7 - 9B using the conveying rollers 210, 211, 212, 310, 311, 312, 610, 611, and 612 having the separation mechanism illustrated in FIGS. 1A and 1B.

The error controller S03 plays a role of controlling the conveyance sensors 3001 to 3022 illustrated in FIGS. 2A and 2B to monitor the state of the conveyed sheet during the print job, and immediately notifying the device control supervisory portion S01, the separation controller S02, and the conveyance controller S05 of an error when a failure is detected.

In addition to the scheduling for the print job at the normal time, the job management portion S04 performs temporary storage of job data for recovery from the conveyance failure detected by the error controller S03, regeneration of data so that the page order is matched, and re-scheduling control after recovery.

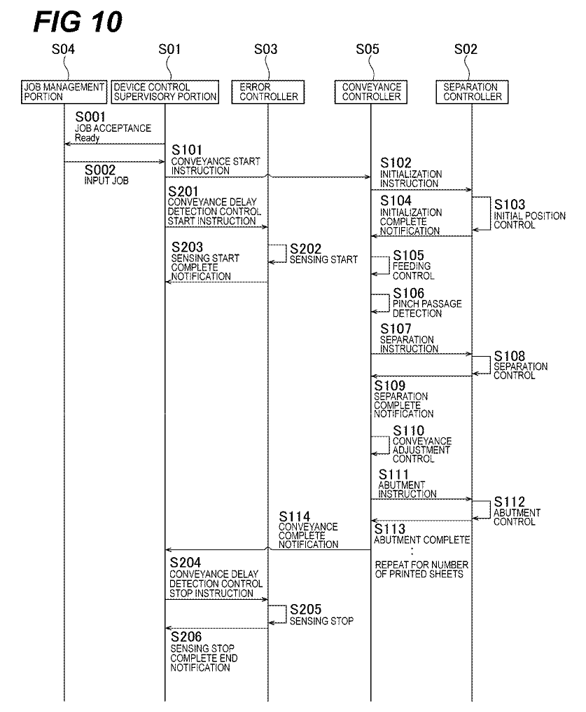

In addition to the conveyance control of the recording sheet with respect to the print job at the normal time, the conveyance controller S05 performs the retraction control of the fed recording sheet to the temporary discharge destination and the re-conveyance control with respect to the recovery job at the time of occurrence of the conveyance failure to be described later with reference to FIG. 10.

### Image Forming Apparatus and Conveyance Sequence

Next, a conveyance sequence in the present embodiment will be specifically described with reference to cross-sectional views of the image forming apparatus in FIGS. 7 - 9B.

As schematically described with reference to FIG. 2B, in the present embodiment, when a sheet conveyance failure occurs, the conveyance of the recording sheet causing the conveyance failure is immediately stopped. On the other hand, for a recording sheet that is not affected by the conveyance failure and is at a position where the image forming process can be continued, conveyance control is continued as a normal sheet, and the recording sheet is discharged to the discharge stacker 601 of the discharging portion 601 that is a normal discharge destination. Further, for a recording sheet on the conveyance path at the position where the printing control cannot be continued in the printing portion 200, the recording sheet is discharged by switching the conveyance path such that the recording sheet is discharged to the nearest discharge ports 120, 320, and 501 as an abnormal sheet. As a result, even in a production machine for commercial printing having a long conveyance path, abnormal sheets can be collectively removed at each discharge destination, and the downtime can be shortened.

Note that, in order to perform control so as to discharge the recording sheets as abnormal sheets to the nearest discharge ports 120, 320, and 501, the position of the fed recording sheet at the time of occurrence of conveyance failure needs to be at a position upstream of the conveyance branches 130, 401, and 502 for guiding the recording sheets to the discharge ports 120, 320, and 501. In addition, when a conveyance failure occurs in a range from the first conveyance branch 130 to the second conveyance branch 401, within this range, no conveyance path that branches toward the discharge port is provided for the recording sheet located upstream of the sheet in which the conveyance failure occurs. That is, since the sheet cannot be conveyed to the second conveyance branch 401, the sheet cannot be retracted to the discharge port 320 or the discharge port 501. Therefore, when a conveyance failure occurs in a sheet in the above range, the sheet is retained, so that it is necessary to immediately stop the conveyance of the subsequent sheet.

In addition, when the position where the sheet conveyance failure has occurred is near the inkjet head 201, it is also necessary to separate the conveying rollers 210, 211, and 212 provided upstream of the inkjet head 201 and downstream of the first conveyance branch 130 to prevent the recording sheet upstream of the head from additionally entering the head 201. In other words, collision avoidance is required in a region in which the first conveyance branch 130, which is the nearest conveyance branch located upstream of the inkjet head 201, is a start point and the second conveyance branch 401, which is the nearest conveyance branch located downstream of the inkjet head 201, is an end point. Therefore, when a sheet conveyance failure occurs in the predetermined region, the conveying rollers 210, 211, and 212 upstream of the head 201 are controlled to be separated. As a result, the conveyance of the subsequent recording sheet is immediately stopped.

Here, the nearest conveyance branch is a conveyance branch closest to the inkjet head 201 on the conveyance path among conveyance branches provided upstream (or downstream) of the inkjet head 201 when there is a plurality of conveyance branches upstream (or downstream) thereof.

In addition, it is assumed that synchronization of the conveyance stop control is delayed between the conveyance region controlled by the CPU 1001 (first hardware) and the conveyance region controlled by the ASIC processor 1010 as a factor that the recording sheet remaining in the inkjet head 201 enters at the time of occurrence of conveyance failure. In the present embodiment, the drive control of the conveying rollers 210, 211, 212, 310, 311, 312, 610, 611, and 612 is controlled by the CPU 1001.

On the other hand, the drive control of the belts such as the print belt 220, the heater belt 301, and the fixing belt 302 as a recording region conveyance member that conveys the recording sheet to the image forming region by the inkjet head 201 is controlled by the ASIC processor 1010 (second hardware) capable of performing more precise control than the CPU 1001.

Then, there may be a case where the regions of the belts 220, 301, and 302 that are immediately stopped by the ASIC processor 1010 when a sheet conveyance failure occurs and the stop timings of the conveying rollers 210, 211, and 212 that are stopped by the CPU 1001 through the device I/F via the system bus 1005 are not synchronized with each other.

When the stop control of the conveying rollers 210, 211, and 212 is delayed, the recording sheet collides with the preceding sheet and is deformed, and when this occurs in the vicinity of the inkjet head 201, the recording sheet may collide with the inkjet head 201. In order to avoid this, when a conveyance failure occurs in the conveyance region whose conveyance is controlled by the ASIC processor 1010, even before the rotation of the conveying rollers 210, 211, and 212 upstream of the head 201 stops, the control is performed to start the separation operation of the pair of rollers, so that the recording sheet is not immediately conveyed and does not collide with the head 201.

FIG. 7 illustrates a conveyance state of a recording sheet when an image forming process is performed on a duplex printing job. Conveyance control of 19 recording sheets from Sheet1 to Sheet19 is performed on a conveyance path of the image forming apparatus, and feeding, printing, fixing, cooling, reversing, and stacking control are performed in units where the respective recording sheets are present.

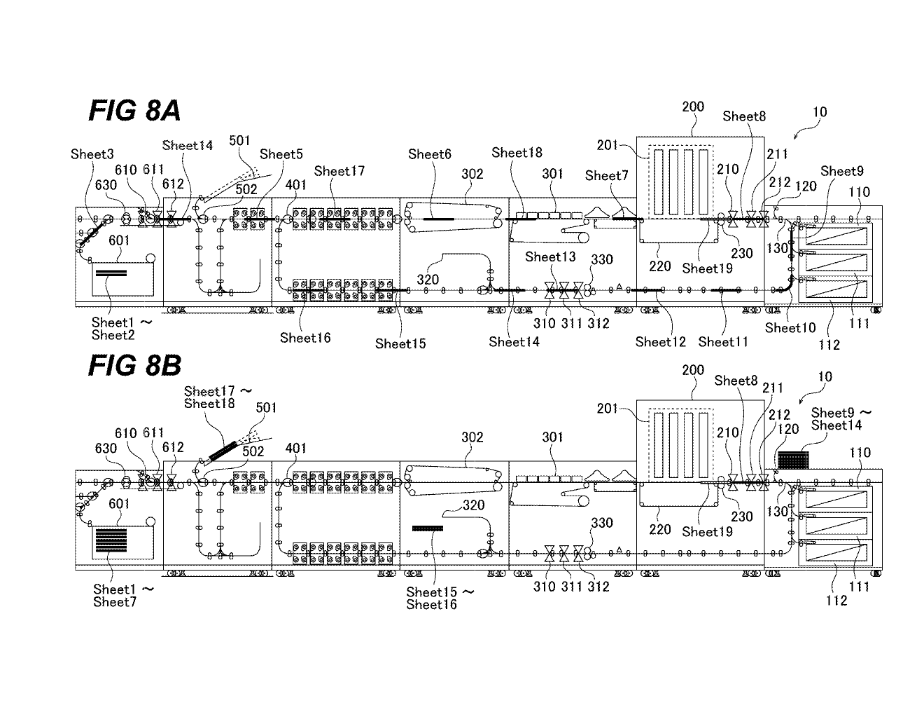

FIG. 8A illustrates the arrangement of the recording sheet when the conveyance failure occurs in Sheet19 existing in the vicinity of the inkjet head 201. In the drawing, the recording sheets from Sheet1 to Sheet7 are sheets whose front and back surfaces have already been printed by the printing portion 200. On the other hand, the recording sheets from Sheet8 to Sheet19 are sheets whose printing has been completed only on the front surface side, and the back surface is in a blank state.

When the retraction control in the present embodiment is performed from the state of FIG. 8A, first, Sheet19, which is an abnormal sheet in which the conveyance failure has occurred, is stopped from being conveyed on the spot. Then, since both the front surface and the back surface of the recording sheets from Sheet1 to Sheet7 are already at the positions where printing is completed, conveyance control is performed so as to discharge the recording sheets as normal sheets to the discharge stacker 601. On the other hand, printing of the recording sheets from Sheet9 to Sheet18 has been completed only on the front surface side, and the back surface remains in a blank state. However, since Sheet19 blocks the conveyance path of the printing portion 200, printing on the back surface becomes impossible. Therefore, the conveyance control is continued by switching the discharge path so that these sheets are discharged as abnormal sheets from the respective positions to the nearest discharge ports 120, 320, and 501.

Then, Sheet8 is at the upstream position of the inkjet head 201, and if the conveyance control is continued, Sheet8 runs into Sheet19 and is deformed, and if Sheet8 proceeds as it is, Sheet8 may collide with the inkjet head 201 and cause a problem. Therefore, the separation control is performed such that the conveying rollers 210, 211, and 212 positioned upstream of the head 201 are separated to release the nip pressure of Sheet8 and immediately stop the conveyance.

On the other hand, similarly to the conveying rollers 210, 211, and 212 (first conveying member) located upstream of the head 201, the conveying rollers 310, 311, 312, 610, 611, and 612 (second conveying member) provided so that the pair of rollers can abut on and separate from each other are disposed at positions other than the upstream position of the head 201. Then, the conveying rollers 310, 311, 312, 610, 611, and 612 continuously drive the pair of rollers without separating the pair of rollers, and convey the sheets other than Sheet19 that has caused the conveyance failure and Sheet8 that stops being conveyed to the discharge stacker 601 and the discharge ports 320 and 501.

As a result, a discharge result as shown in FIG. 8B is finally obtained. That is, the recording sheets from Sheet1 to Sheet7 are discharged to the discharge stacker 601, and Sheet8 and Sheet19 are left as residual sheets on the conveyance path. Sheet9 to Sheet 14 are discharged to the discharge port 120, Sheet15 and Sheet16 are discharged to the discharge port 320, and Sheet17 and Sheet18 are discharged to the discharge port 501. In Sheet19 in which the conveyance failure has occurred, the conveyance failure has occurred in a range in which the nearest conveyance branch 130 located upstream of the inkjet head 201 is a start point and the nearest conveyance branch 401 located downstream of the inkjet head 201 is an end point. Therefore, the conveying rollers 210, 211, and 212 located upstream of the head 201 are immediately separated, and the retraction control is completed.

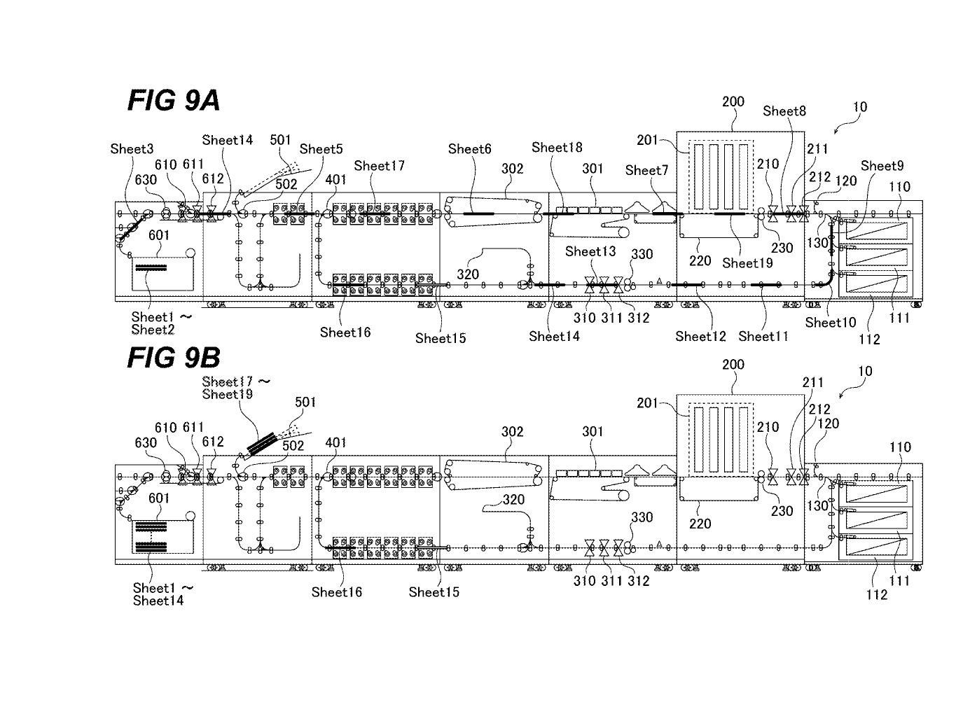

As described above, with reference to FIGS. 8A and 8B, the conveyance sequence of the retraction control of the conveying rollers 210, 211, and 212 upstream of the head 201 has been described in order to avoid the collision between the head 201 and the recording sheet in a case of the occurrence of the conveyance failure in the vicinity of the inkjet head 201. On the other hand, when this condition is not satisfied, there is no need to perform retraction control by separating the conveying rollers 210, 211, and 212 upstream of the head 201, and it is better to continue the conveyance control so that a residual sheet does not remain in the apparatus as much as possible while the rollers remain abutting each other. FIGS. 9A and 9B illustrate a conveyance sequence in such a case.

FIG. 9A illustrates the arrangement of recording sheets in a case where conveyance failure occurs in Sheet15 guided to the conveyance path for printing on the back surface by the conveyance branch 401 of the cooling portion 400 and reaching the vicinity of the inlet of the fixing portion 300. When the retraction control according to the present embodiment is performed from this state, Sheet15 in which the conveyance failure has occurred is first stopped from being conveyed on the spot.

Since both the front surface and the back surface of the recording sheets from Sheet1 to Sheet14 have already been printed in the printing portion or are at a position where printing can be completed, conveyance control is performed so as to discharge the recording sheets as normal sheets to the discharge stacker 601. On the other hand, printing has been completed only on the front surface side of Sheet17 to Sheet19, and the back surface remains blank. However, since Sheet15 blocks the conveyance path for printing on the back surface of the cooling portion 400, the conveyance of Sheet16 located upstream thereof cannot be continued, and the residual sheet blocks up to the conveyance path of the printing portion, so that printing on the back surface becomes impossible. Therefore, the conveyance control is continued by switching the discharge path so that the sheet is discharged to the nearest discharge port 501 as the abnormal sheet. In this case, there is no recording sheet in which the conveyance failure has occurred in the vicinity of the inkjet head 201 and in the conveyance region controlled to be conveyed by the ASIC processor 1010. Therefore, there is no cause of collision with the inkjet head 201 to cause a problem. The conveying rollers 210, 211, and 212 located upstream of the inkjet head 201 are not separated, and the conveyance control of the other recording sheets is continued while the rollers remain abutting each other.

As a result, a discharge result as shown in FIG. 9B is finally obtained. The recording sheets from Sheet1 to Sheet14 are discharged to the discharge stacker 601, and Sheet15 and Sheet6 are left as residual sheets on the conveyance path. Sheet17 to Sheet19 are discharged to the discharge port 501.

As described above, when the region where the conveyance failure of the sheet is detected is at a position other than the region from the first conveyance branch 130 to the second conveyance branch 401, the subsequent recording sheet does not enter the inkjet head 201. Therefore, the conveying rollers 210, 211, and 212 located upstream of the inkjet head 201 are controlled so as not to be separated from each other, thereby reducing the downtime for removing the residual sheet.

### Sequence of Sheet Conveyance Process

Next, a normal processing sequence of the sheet conveyance process in the present embodiment will be described with reference to FIG. 10. As described with reference to FIG. 6, in the present embodiment, the device control supervisory portion S01 checks whether there is a delay in the conveyance control using the error controller S03 while controlling the printing process in an integrated manner. When the job input from the job management portion S04 is received, the conveyance controller S05 is caused to prepare initialization of image forming control. When a job is started, the conveyance controller S05 starts a recording sheet feeding process and starts conveyance control. In order to finely adjust the conveyance position, monitoring is performed to detect that the recording sheet has been conveyed to a predetermined position, and when it is detected that the recording sheet has arrived, a separation instruction is issued to the separation controller S02, and when the fine adjustment is completed, abutment is instructed. When this control is repeated by the number of printed sheets until the last page, the sensing control of the error controller S03 is stopped, and this sequence is completed.

First, in S001, the device control supervisory portion S01 notifies the job management portion S04 that job acceptance is enabled.

Next, in S002, the job management portion S04 inputs a job of print data to the device control supervisory portion S01.

Next, in S101, the device control supervisory portion S01 issues a recording sheet conveyance start instruction to the conveyance controller S05.

Next, in S102, the conveyance controller S05 issues an initialization instruction to the separation controller S02.

Next, in S103, the separation controller S02 performs separation control so as to be at the initial position where the conveying roller abuts.

Next, in S104, the separation controller S02 notifies the conveyance controller S05 that the initialization control has been completed.

Next, in S105, the conveyance controller S05 starts feeding control of the recording sheet from the sheet tray of the feeding portion.

Next, in S106, the conveyance controller S05 detects that the recording sheet has been conveyed to the position of the adjustment pinch roller for finely adjusting the conveyance position of the recording sheet. The image forming apparatus 10 of the present embodiment includes adjustment pinch rollers 230, 330, and 630 in the printing portion 200, the fixing portion 300, and the discharging portion 600, respectively. In S103, it is detected whether the recording sheet has been conveyed to the position of each of the adjustment pinch rollers 230, 330, and 630.

Next, in S107, the conveyance controller S05 issues a separation instruction to the separation controller S02 so that the separation control is performed on the conveying roller having the separation mechanism corresponding to the adjustment pinch rollers 230, 330, and 630 that have detected the conveyance arrival of the recording sheet in S103.

When it is detected that the recording sheet is conveyed to the position of the adjustment pinch roller 230, a separation instruction is issued to the separation controller S02 to separate the conveying rollers 210, 211, and 212. When it is detected that the recording sheet is conveyed to the position of the adjustment pinch roller 330, a separation instruction is issued to the separation controller S02 to separate the conveying rollers 310, 311, and 312. When it is detected that the recording sheet is conveyed to the position of the adjustment pinch roller 630, a separation instruction is issued to the separation controller S02 to separate the conveying rollers 610, 611, and 612.

Next, in S108, the separation controller S02 separates the conveying roller having the separation mechanism corresponding to the adjustment pinch rollers 230, 330, and 630 that have detected that the recording sheet is conveyed. Next, in S109, the separation controller S02 notifies the conveyance controller S05 that the separation control has been completed.

Next, in S110, the conveyance controller S05 performs conveyance adjustment control for finely adjusting the conveyance position.

Next, in S111, the conveyance controller S05 issues an abutment instruction to the separation controller S02. Next, in S112, the separation controller S02 abuts the conveying roller having the separation mechanism. Next, in S113, the separation controller S02 notifies the conveyance controller S05 that the abutment control has been completed.

Thereafter, the conveyance controller S05 and the separation controller S02 repeat the sequence from S106 to S113 for the number of printed sheets.

Next, in S114, the conveyance controller S05 notifies the device control supervisory portion S01 that the conveyance control has been completed.

Conveyance failure detection control is also performed in parallel with the conveyance control from S101 to S114.

First, in S201, the device control supervisory portion S01 instructs the error controller S03 to start control of sensing the conveyance state and detecting whether a conveyance delay has occurred.

Next, in S202, the error controller S03 starts sensing of the conveyance sensor. Next, in S203, the error controller S03 notifies the device control supervisory portion S01 that the sensing of the conveyance sensor has started.

Next, in S204, the device control supervisory portion S01 instructs the error controller S03 to stop the conveyance delay detection control. Next, in S205, the error controller S03 stops sensing of the conveyance sensor. Next, in S206, the error controller S03 notifies the device control supervisory portion S01 that the sensing of the conveyance sensor has been stopped.

According to the above sequence, the normal sheet conveyance process is performed.

### Sequence of Conveyance Failure Detection Control

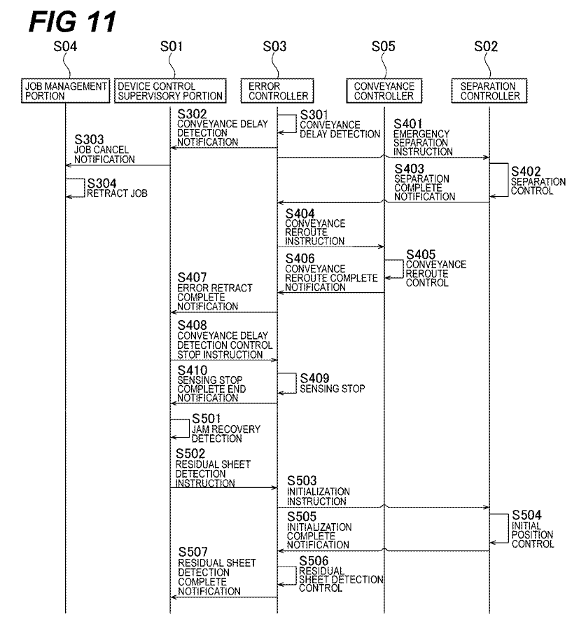

Next, a processing sequence at the time of detecting a conveyance failure in the image forming process in the present embodiment will be described with reference to FIG. 11. In the present embodiment, when the error controller S03 detects the conveyance delay during the image forming process, the separation controller S02 is immediately notified to separate the conveying rollers 210, 211, and 212 upstream of the head 201. In addition, the device control supervisory portion S01 is also notified in parallel, and the job management portion S04 performs control to temporarily store job data to prepare for job re-input after error recovery. In addition, a reroute instruction is issued to the conveyance controller S05 to retract the recording sheet being conveyed to a predetermined discharge destination.

When the retraction control of the conveyance controller S05 is completed, the sensing of the conveyance sensor is stopped, and the processing waits for the user to complete the removal of the residual sheet. When the device control supervisory portion S01 detects the completion of the removal of the residual sheet, checks whether there is a residual sheet using the conveyance controller S05, and then notifies the job management portion S04 of the completion of the recovery, and instructs the job management portion S04 to re-input the job to complete the processing.

First, in S301, the error controller S03 detects that the leading edge of the recording sheet has not been detected for a predetermined time from the conveyance sensor that is sensing, and determines that a conveyance failure has occurred.

Next, in S302, the error controller S03 notifies the device control supervisory portion S01 of detection of the conveyance failure.

Next, in S303, the device control supervisory portion S01 notifies the job management portion S04 of job cancellation.

Next, in S304, the job management portion S04 stores the job data in the middle of the image forming process to a predetermined storage region.

In parallel, in S401, the error controller S03 instructs the separation controller S02 to perform emergency separation control.

Next, in S402, the separation controller S02 separates the conveying rollers 210, 211, and 212.

Next, in S403, the separation controller S02 notifies the error controller S03 that the separation control has been completed.

Next, in S404, the error controller S03 instructs the conveyance controller S05 to perform conveyance reroute control of changing the conveyance path of the fed recording sheet and retracting the recording sheet to the temporary retraction destination.

Next, in S405, the conveyance controller S05 performs the conveyance reroute control described with reference to FIGS. 7 - 9B on all the fed recording sheets.

Next, in S406, the conveyance controller S05 notifies the error controller S03 that the conveyance reroute control has been completed.

Next, in S407, the error controller S03 notifies the device control supervisory portion S01 that the error retraction control has been completed.

Next, in S408, the device control supervisory portion S01 instructs the error controller S03 to stop the conveyance sensor monitoring control for detecting the conveyance delay.

Next, in S409, the error controller S03 stops the monitoring of the conveyance sensor.

Next, in S410, the error controller S03 notifies the device control supervisory portion S01 that the conveyance sensor monitoring has been stopped.

Then, in S501, the device control supervisory portion S01 detects from the UI (not illustrated) that the removal of the residual sheet (jam recovery) has been completed by the user.

Then, in S502, the device control supervisory portion S01 instructs the error controller S03 to perform residual sheet detection control for checking whether any other residual sheet remains.

Next, in S503, the error controller S03 issues an initialization instruction to the separation controller S02 in order to return the conveying roller separated in S402 to a position where the conveying roller can be driven for a predetermined time for detecting a residual sheet.

Next, in S504, the separation controller S02 performs an initialization instruction so as to be at the initial position where the conveying roller abuts.

Next, in S505, the separation controller S02 notifies the error controller S03 that the initialization control has been completed.

Next, in S506, the error controller S03 performs residual sheet detection control of driving all the conveying rollers for a predetermined time to check whether any other recording sheets still remain.

Next, in S507, the error controller S03 notifies the completion of the residual sheet detection control to the device control supervisory portion S01 together with the result.

According to the above sequence, the image forming process at the time of conveyance failure detection is performed.

Next, details of control of the present embodiment will be described with reference to a flowchart. Note that the CPU 1001 used in the following description may be a CPU on a controller unit separately present in each of the feeding portion 100, the printing portion 200, the fixing portion 300, the cooling portion 400, the reversing portion 500, and the discharging portion 600 on which each processing is performed.

### Flowchart of Image Forming Control

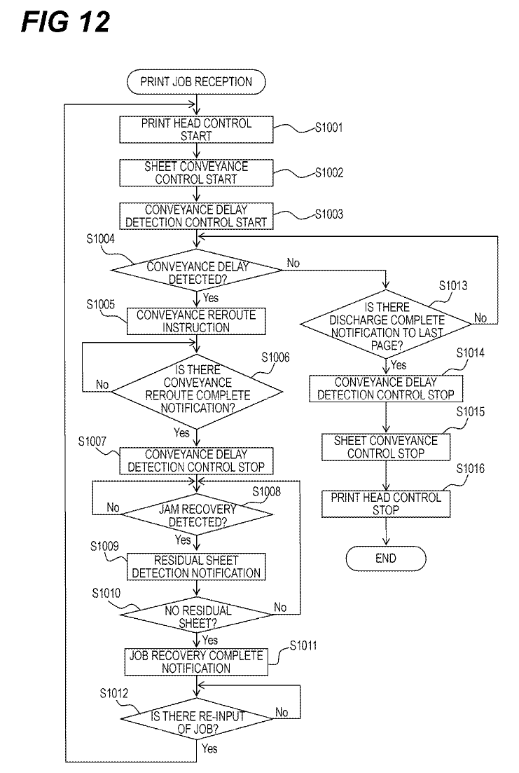

Next, an overall flow of image forming control by the device control supervisory portion S01 in the present embodiment will be described with reference to a flowchart of FIG. 12.

In the image forming apparatus according to the present embodiment, when the device control supervisory portion S01 receives a print job, the error controller S03 starts conveyance failure detection control, the conveyance controller S05 starts conveyance of the recording sheet, and performs printing process. When the error controller S03 detects a conveyance failure during the print control, the separation controller S02 immediately separates the conveying rollers 210, 211, and 212 upstream of the head 201, and the conveyance controller S05 discharges the fed recording sheet to a predetermined discharge destination, and ends the printing process. Thereafter, when the completion of the removal of the residual sheet by the user is detected from the UI (not illustrated) by the device control supervisory portion S01, the error controller S03 performs control of returning the separated conveying rollers 210, 211, and 212 to the abutment positions by the separation controller S02 to detect the residual sheet, and performs the error recovery process. Thereafter, the device control supervisory portion S01 receives the print job again, and stops the conveyance delay detection control and the known head control and ends the processing when the discharging to the last page is completed without detecting any particular failure by the conveyance controller S05.

In the flow illustrated in FIG. 12, control is started when transmission of a print job to the image forming apparatus 10 is detected.

First, in S1001, the CPU 1001 moves the inkjet head 201 from the initial position to start known head control for ejecting ink onto the recording sheet and printing.

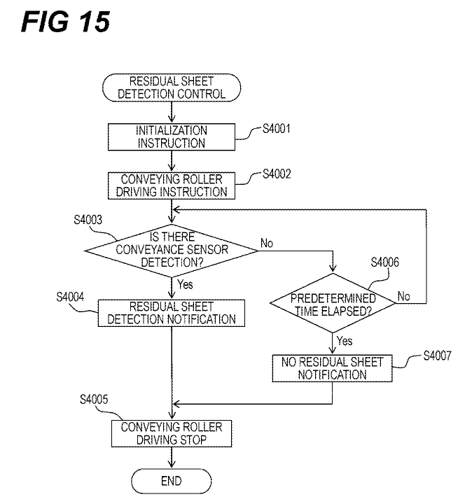

Next, in S1002, the CPU 1001 starts sheet conveyance control for conveying the recording sheet. Details of the sheet conveyance control will be described later in detail with reference to FIG. 15.

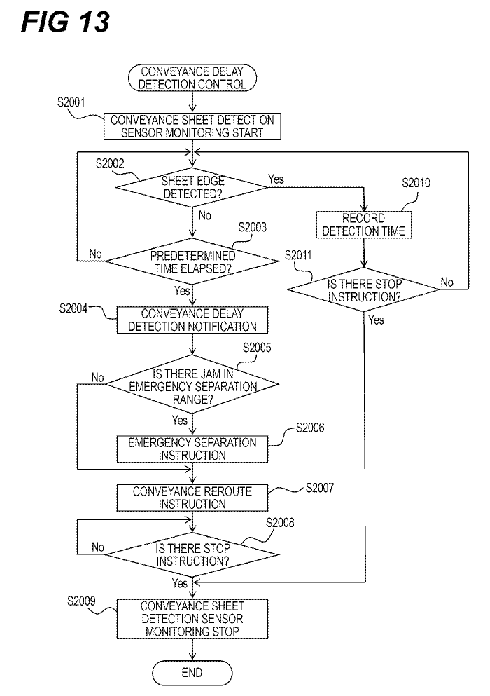

Next, in S1003, the CPU 1001 starts conveyance delay detection control for monitoring whether conveyance of the recording sheet is delayed. Details of the conveyance delay detection control will be described later in detail with reference to FIG. 13.

Next, in S1004, the CPU 1001 determines whether a conveyance delay has been detected in the conveyance delay detection control started in S1002. When the conveyance delay is detected, the processing proceeds to S1005. When the conveyance delay is not detected, the processing proceeds to S1013.

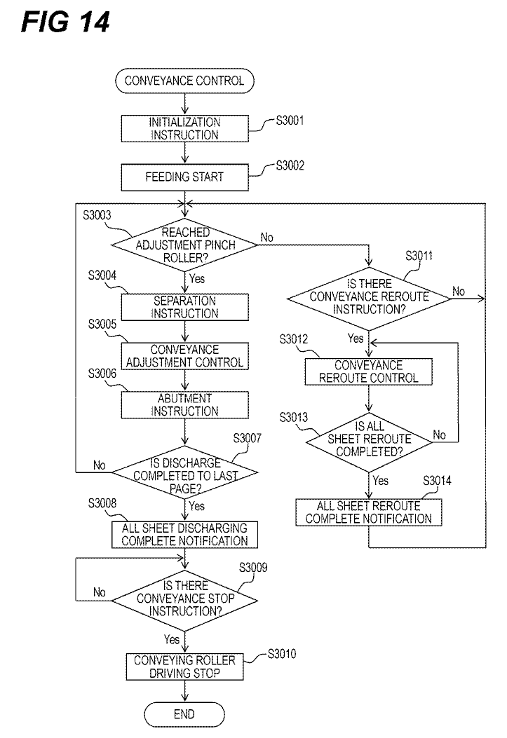

Next, in S1005, the CPU 1001 issues a conveyance reroute instruction to a conveyance controller S05 to be described later with reference to FIG. 14 in order to store the job data on which an image is currently being formed and retract the fed recording sheet.

Next, in S1006, the CPU 1001 determines whether the conveyance reroute control is performed by the conveyance controller S05, and a notification that all the recording sheets fed up to the last page have been completely discharged comes from S3014 to be described later with reference to FIG. 14. When the discharge completion notification has arrived, the processing proceeds to S1007. When the discharge completion notification has not been received, S1006 is repeated until the discharge completion notification is received.

Next, in S1007, the CPU 1001 stops conveyance delay detection control for monitoring whether conveyance of the recording sheet to be described later with reference to FIG. 13 is delayed.

Next, in S1008, the CPU 1001 determines whether the UI (not illustrated) has detected that the residual sheet removal by the user has been completed. In the image forming apparatus 10 of the present embodiment, whether the residual sheet removal has been completed is detected by the user pressing a residual sheet removal completion button on a UI screen (not illustrated), and the processing proceeds to the next control. When it is detected that the residual sheet removal has been completed, the processing proceeds to S1009. In a case where it is not detected that the residual sheet removal has been completed, S1008 is repeated until a notification indicating that the residual sheet removal has been completed arrives.

Next, in S1009, the CPU 1001 performs a residual sheet detection process. Details of the residual sheet detection process will be described later in detail with reference to FIG. 15.

Next, in S1010, the CPU 1001 determines whether there is no residual sheet by the residual sheet detection process performed in S1009. When there is no residual sheet, the processing proceeds to S1011. In a case where there is still a residual sheet present, the residual sheet information is notified to the user by a UI (not illustrated) to urge the user to remove the residual sheet, the processing returns to S1008, and the process is repeated.

Next, in S1011, the CPU 1001 notifies a print server (not illustrated) that job recovery has been completed, and prompts the re-input of the job.

Next, in S1012, the CPU 1001 determines whether a job has been re-input from the print server (not illustrated). When the job is re-input, the processing returns to S1001, and reprinting is performed. When the job has not been re-input, S1012 is repeated until the job is re-input.

When the conveyance delay is not detected in S1004, the CPU 1001 determines whether the printing process is controlled without any problem and the discharging to the last page is completed in S1013. When the discharging to the last page has been completed, the processing proceeds to S1014. When the discharging to the last page has not been completed, the processing returns to S1004, and the processing is repeated.

When the discharging to the last page has been completed, in S1014, the CPU 1001 stops the conveyance delay detection control performed in S1003.

Next, in S1015, the CPU 1001 stops the recording sheet conveyance control performed in S1002.

Next, in S1016, the CPU 1001 stores the inkjet head 201 at the initial position to stop the known head control performed in S1001, and ends this flow.

Through the above processing, the image forming control in the present embodiment is performed.

### Flowchart of Conveyance Failure Detection Control

Next, sheet conveyance failure detection control performed by the error controller S03 according to the present embodiment will be described with reference to a flowchart of FIG. 13.

In the sheet conveyance failure detection control performed by the error controller S03, the conveyance failure is detected based on whether the leading edge of the conveyed recording sheet is detected within a range of assumed time by the conveyance sensors 3001 to 3022 installed on the conveyance path described with reference to FIGS. 2A and 2B. When the processing starts, the conveyance sensor is continuously monitored until there is a stop instruction, and when the sheet is not detected within a predetermined time, it is determined that a conveyance failure has occurred. This flow is started by an instruction from the device control supervisory portion S01 in S1003 of FIG. 12.

First, in S2001, the CPU 1001 starts monitoring the conveyance sensors 3001 to 3022 installed on the conveyance path in order to detect the leading edge of the recording sheet.

Next, in S2002, the CPU 1001 determines whether the leading edge of the sheet has been sequentially detected by the conveyance sensors 3001 to 3022 that are monitoring. When the leading edge of the sheet is detected, the processing proceeds to S2001. When the leading edge of the sheet is not detected, the processing proceeds to S2003.

Next, in S2003, the CPU 1001 determines whether a predetermined time has elapsed from the start of feeding of the recording sheet until the leading edge of the sheet is sequentially detected by any of the conveyance sensors 3001 to 3022. When the predetermined time has elapsed, the processing proceeds to S2004. Otherwise, the processing returns to S2002.

Next, in S2004, the CPU 1001 determines that the leading edge of the sheet cannot be detected from any one of the conveyance sensors 3001 to 3022 even after a predetermined time has elapsed, and that a failure has occurred in conveyance, and notifies the device control supervisory portion S01 of conveyance delay detection. Although described with reference to FIGS. 2A and 2B, the image forming apparatus 10 of the present embodiment monitors the conveyance state of the recording sheet with the conveyance sensors 3001 to 3022 on the conveyance path, and determines that a conveyance failure has occurred when the difference between the assumed time and the actual conveyance time is larger than a predetermined range. The conveyance delay detection notified to the device control supervisory portion S01 in S2004 is referred to in S1004 in FIG. 12.

Next, in S2005, the CPU 1001 determines whether emergency separation of the conveying rollers 210, 211, and 212 is necessary. Here, it is determined whether the conveyance sensor that has detected the conveyance failure is the sensor 3003, 3004, 3005, 3006, 3007, 3008, or 3009 at a position where separation of the conveying rollers 210, 211, and 212 upstream of the head 201 is required. Here, as described with reference to FIGS. 7 - 9B, the sensor position where the emergency separation is required is a position corresponding to a range having a conveyance branch point 130 located upstream of the inkjet head 201 as a start point and a conveyance branch point 401 located downstream of the inkjet head 201 as an end point. The position is also a position corresponding to the regions of the belts 220, 301, and 302 controlled to be conveyed by the ASIC processor 1010. When the emergency separation is required, the processing proceeds to S2006. When the separation is unnecessary, the processing proceeds to S2007.

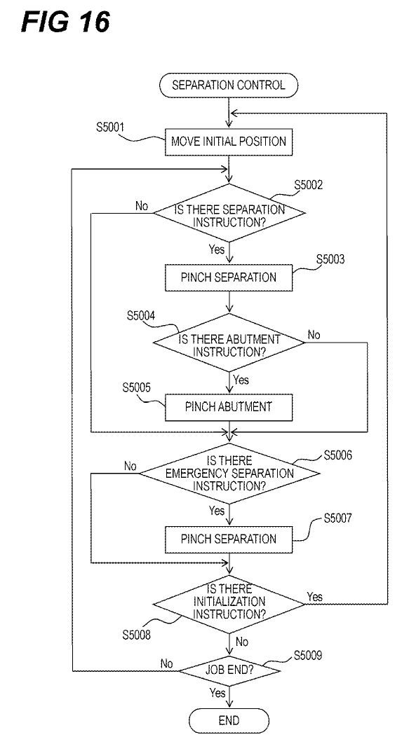

Next, in S2006, the CPU 1001 instructs emergency separation with respect to the conveying rollers 210, 211, and 212 upstream of the head 201. Details of the emergency separation will be described later in detail with reference to FIG. 16.

Next, in S2007, the CPU 1001 instructs conveyance reroute of the fed recording sheet. Details of the conveyance reroute will be described later in detail with reference to FIG. 14.

Next, in S2008, the CPU 1001 determines whether there is an instruction to stop the conveyance failure detection control in S1007 of FIG. 12 from the device control supervisory portion S01. When the stop instruction is received, the processing proceeds to S2009. When there is no stop instruction, S2008 is repeated until there is a stop instruction.

Next, in S2009, the CPU 1001 stops monitoring of the conveyance sensors 3001 to 3022 installed on the conveyance path, and ends this flow.

When the leading edge of the sheet is sequentially detected by the conveyance sensors 3001 to 3022 in S2002, the CPU 1001 records the time when the leading edge of the sheet is detected by the conveyance sensor as an internal log in S2010.

Next, in S2011, the CPU 1001 determines whether there is an instruction to stop the conveyance failure detection control in S1014 of FIG. 12 from the device control supervisory portion S01. When the stop instruction is received, the processing proceeds to S2009. When there is no stop instruction, the processing returns to S2002, and the processing is repeated.

Through the above processing, the conveyance failure detection control in the present embodiment is performed.

### Flowchart of Conveyance Control

Next, processing of sheet conveyance control in the present embodiment performed by the conveyance controller S05 will be described with reference to a flowchart of FIG. 14.

When the printing process is started, the conveying roller is rotated to start conveyance of the recording sheet from the feeding portion. The image forming apparatus 10 according to the present embodiment adjusts the conveyance position of the recording sheet on a predetermined conveyance path during conveyance control so that a printed image is correctly printed at a predetermined position on the recording sheet by the inkjet head 201. In the conveyance position adjustment, the skew of the recording sheet with respect to the conveyance direction and the deviation of the conveyance sensor arrival time are detected, and the conveyance position is adjusted using a predetermined adjustment pinch roller. At this time, adjustment control is performed by releasing the nip pressure of the recording sheet to be conveyed with respect to the conveying roller using the conveying rollers 210, 211, 212, 310, 311, 312, 610, 611, and 612 having the separation mechanism described above. Therefore, whether or not the recording sheet reaches the vicinity of the upstream of the conveyance position adjustment position is detected from the sheet leading edge detection information of the conveyance sensor, and the conveying roller is separated at a timing when the recording sheet reaches the predetermined position.

Further, when a reroute instruction for changing the conveyance path due to the conveyance failure detection is notified, the reroute control is performed, and when the discharging to the discharge port is completed up to the last page, after a notification indicating that the conveyance control of all the sheets is completed is issued, the conveying rollers are stopped, and this flow is terminated. When the sheet conveyance control is instructed from the device control supervisory portion S01 in S1002 of FIG. 12, this flow is started.

First, in S3001, the CPU 1001 issues an instruction to move the conveying rollers 210, 211, 212, 310, 311, 312, 610, 611, and 612 having the separation mechanism to the initial position so as to be brought into an abutment position with the paired driven rollers in order to convey the recording sheet using the conveying rollers.

Next, in S3002, the CPU 1001 starts feeding control of the recording sheet from the feeding portion 100.

Next, in S3003, the CPU 1001 determines whether the recording sheet has been conveyed to the positions of the adjustment pinch rollers 230, 330, and 630 for performing fine adjustment of the conveyance position. When it is determined that the recording sheet has been conveyed to the position of the corresponding adjustment pinch rollers 230, 330, and 630, the processing proceeds to S3004. When it is determined that the recording sheet has not been conveyed yet, the processing proceeds to S3012.

Next, in S3004, the CPU 1001 issues a separation instruction to the separation mechanism of the conveying rollers 210, 211, 212, 310, 311, 312, 610, 611, and 612 that perform fine adjustment. Then, in S3005, the CPU 1001 performs the conveyance position adjustment control described with reference to FIGS. 4A and 4B.

Next, in S3006, the CPU 1001 issues an abutment instruction to the conveying rollers 210, 211, 212, 310, 311, 312, 610, 611, and 612 having the separation mechanism.

Next, in S3007, the CPU 1001 determines whether the conveyance control has been completed up to the last page and all pages have been discharged. When all the pages have not been discharged, the processing proceeds to S3008. When all the pages have been discharged, the processing proceeds to S3009.

Next, in S3008, the CPU 1001 notifies the device control supervisory portion S01 that the conveyance of all the recording sheets has been completed, and the processing proceeds to S1013 in FIG. 12.

Next, in S3009, the CPU 1001 determines whether there is a conveyance stop instruction in S1015 of FIG. 12 from the device control supervisory portion S01. When the conveyance stop instruction is received, the processing proceeds to S3009. When there is no conveyance stop instruction, the processing returns to S3003, and the processing is repeated.

Next, in S3010, the CPU 1001 stops driving the conveying roller and ends this flow.

When the sheet is not conveyed to the positions of the adjustment pinch rollers 230, 330, and 630 in S3003, the CPU 1001 determines in S3011 whether there is a conveyance reroute instruction in S1005 of FIG. 12 from the device control supervisory portion S01. When the conveyance reroute instruction is received, the processing proceeds to S3012. When there is no conveyance reroute instruction, the processing returns to S3003, and the processing is repeated.

Next, in S3012, as described with reference to FIGS. 7 - 9B, the CPU 1001 switches the conveyance path and conveys the fed recording sheet so as to be retracted to a predetermined discharge destination according to each position.

Next, in S3013, the CPU 1001 switches the conveyance path of all the sheets and determines whether retraction to a predetermined discharge destination has been completed. When the processing has been completed, the processing proceeds to S3014. When the processing has not been completed, the processing returns to S3012, and the processing is repeated.

Next, in S3014, the CPU 1001 notifies the device control supervisory portion S01 that the conveyance paths of all the sheets have been switched and the retraction to the predetermined discharge destination has been completed, and the processing proceeds to S1005 of FIG. 12.

Through the above processing, the conveyance control in the present embodiment is performed.

### Flowchart of Residual Sheet Detection Control

Next, processing of the residual sheet detection control in the present embodiment performed by the error controller S03 will be described with reference to a flowchart of FIG. 15.

After the occurrence of the conveyance failure of the sheet, and then after the removal of the residual sheet by the user is completed, it is confirmed whether any other residual sheet still remains in the conveyance path and whether normal operation can be restored. This residual sheet detection is control for this purpose, and first, the conveying rollers 210, 211, 212, 310, 311, 312, 610, 611, and 612 once separated by the separation controller S02 are returned to the abutment positions again. Then, the conveying rollers are driven for a predetermined time to confirm whether the conveyance sensors 3001 to 3022 detect the leading edge of the sheet. When a sheet detection signal is received from any one of the conveyance sensors 3001 to 3022, it is notified to the device control supervisory portion S01 that a residual sheet has been detected. On the other hand, when nothing is detected, the device control supervisory portion S01 is notified that there is no residual sheet, and the processing is stopped. When the residual sheet detection is instructed from the device control supervisory portion S01 in S1010 of FIG. 12, this flow is started.

First, in S4001, the CPU 1001 issues an instruction to move the conveying rollers 210, 211, 212, 310, 311, 312, 610, 611, and 612 having the separation mechanism to the initial position so as to be brought into an abutment position with the paired driven rollers in order to convey the recording sheet using the conveying rollers.

Next, in S4002, the CPU 1001 starts driving of the conveying roller.

Next, in S4003, the CPU 1001 checks whether the leading edge of the sheet has been detected from the conveyance sensors 3001 to 3022. When the leading edge of the sheet is detected, the processing proceeds to S4004. When the leading edge of the sheet is not detected, the processing proceeds to S4006.

Next, in S4004, the CPU 1001 notifies the device control supervisory portion S01 that a residual sheet has been detected, and the control proceeds to S1010 of FIG. 12.

Next, in S4005, the CPU 1001 stops driving of the conveying roller and ends this flow.

When the leading edge of the sheet is not detected by the conveyance sensors 3001 to 3022 in S4003, the CPU 1001 further drives the conveying roller and determines whether a predetermined time has elapsed in S4006. When the predetermined time has elapsed, the processing proceeds to S4007. In a case where the predetermined time has not elapsed, the processing returns to S4003, and the processing is repeated.

Next, in S4007, since the leading edge of the sheet is not detected by the conveyance sensors 3001 to 3022 even if the conveying rollers are driven for a predetermined time, the CPU 1001 determines that there is no residual sheet, notifies the device control supervisory portion S01 of the determination, and the processing proceeds to S1010 of FIG. 12.

Through the above processing, the residual sheet detection control in the present embodiment is performed.

### Flowchart of Separation Control

Next, the separation control in the present embodiment performed by the separation controller S02 will be described with reference to a flowchart of FIG. 16.

The image forming apparatus 10 according to the present embodiment includes conveying rollers 210, 211, 212, 310, 311, 312, 610, 611, and 612 having a separation mechanism. In order to perform the conveyance position adjustment during the conveyance control described with reference to FIGS. 4A, 4B, and 14 using the adjustment pinch rollers 230, 330, and 630, the conveyance controller S05 instructs the separation controller S02 to perform the separation control of the conveying rollers having these separation mechanisms. When a conveyance failure occurs near the inkjet head 201 during the conveyance control, the conveying rollers 210, 211, and 212 are separated in an emergency by an instruction of the error controller S03 in order to prevent the upstream recording sheet from additionally entering the lower portion of the head 201 and colliding with the head 201. After the emergency separation, the residual sheet is removed by the user, and after the completion is detected from a UI (not illustrated), the residual sheet detection control by the error controller S03 described with reference to FIG. 15 is performed. At this time, an initialization instruction is issued from the error controller S03 to the separation controller S02, and the conveying roller that has been separated in an emergency is returned to the abutment position. When an initialization instruction is notified by the conveyance controller S05 in S3001 of FIG. 14, this flow is started.

First, in S5001, the CPU 1001 drives the separating motors of the conveying rollers 210, 211, 212, 310, 311, 312, 610, 611, and 612 to bring the respective conveying rollers H04 and the driven rollers H03 abut against each other so that the recording sheet can be nipped and conveyed.

Next, in S5002, the CPU 1001 determines whether there is a separation instruction in S3004 of FIG. 14 from the conveyance controller S05. When there is the separation instruction, the processing proceeds to S5003. When there is no separation instruction, the processing proceeds to S5006.

Next, in S5003, the CPU 1001 drives the separating motors of the conveying rollers 210, 211, 212, 310, 311, 312, 610, 611, and 612 to separate the conveying roller H04 and the driven roller H03 so as to be separated from each other (FIG. 3B). When the conveying roller H04 and the driven roller H03 are already at the separated positions, the processing proceeds to S5004 without doing anything.

Next, in S5004, the CPU 1001 determines whether there is an abutment instruction in S3006 of FIG. 14 from the conveyance controller S05. When the abutment instruction is received, the processing proceeds to S5005. When there is no abutment instruction, the processing proceeds to S5006.

Next, in S5005, the CPU 1001 drives the separating motors of the conveying rollers 210, 211, 212, 310, 311, 312, 610, 611, and 612, and performs abutting driving so that the conveying roller H04 and the driven roller H03 are at abutment positions. When the conveying roller H04 and the driven roller H03 are already at the abutment positions, the processing proceeds to S5006 without doing anything.

Next, in S5006, the CPU 1001 determines whether there is an emergency separation instruction in S2006 of FIG. 13 from the error controller S03. When there is an emergency separation instruction, the processing proceeds to S5007. When there is no emergency separation instruction, the processing proceeds to S5008.

Next, in S5006, the CPU 1001 drives the separating motor of each of the conveying rollers 210, 211, and 212 upstream of the head 201, and drives the separating motor such that the conveying roller H04 and the driven roller H03 are separated from each other. When the conveying roller H04 and the driven roller H03 are already at the separated positions, the processing proceeds to S5008 without doing anything.

Next, in S5008, the CPU 1001 determines whether there is an initialization instruction in S4001 of FIG. 15 from the error controller S03. When the initialization instruction is received, the processing returns to S5001. When there is no initialization instruction, the processing proceeds to S5009.

Next, in S5009, the CPU 1001 determines whether the job has been terminated. When the job is terminated, this flow is terminated. When the job is not finished, the processing returns to S5002.

Through the above processing, the separation control in the present embodiment is performed. The separation control of this flow may be controlled by the ASIC processor 1010.

As described above, according to the present embodiment described so far, when a conveyance failure occurs in the vicinity of the inkjet head 201, the conveying rollers 210, 211, and 212 upstream of the head 201 are immediately separated, and the conveyance of the recording sheet upstream of the head 201 is immediately stopped to prevent collision with the head 201. Conveyance control for other recording sheets that are not affected by the conveyance failure is performed such that the conveyance path is switched and continued to retract the recording sheets to a predetermined temporary retraction destination. As a result, it is possible to prevent failures due to collision between the inkjet head 201, which is a precision portion, and the recording sheet while reducing the downtime for removing the residual sheet by performing the retraction control of the residual sheet according to the conveyance failure occurrence position.

In a case where conveyance failure of the recording medium occurs, it is possible to protect the image forming portion while reducing the downtime for removing the recording medium.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-077172, filed May 7, 2025, which is hereby incorporated by reference herein in its entirety.

What is claimed is:

1. An image forming apparatus comprising:
an ink head configured to eject ink onto a recording medium to form an image;
a conveyance portion including a first conveyance member configured to nip and convey the recording medium by a pair of rotating members disposed upstream of the ink head in a conveyance direction of the recording medium;
a separation portion configured to separate the pair of rotating members from each other;
a first sensor configured to detect the recording medium conveyed along a conveyance path;
a second sensor configured to detect the recording medium at a position different from a position of the first sensor; and
a controller configured to perform control to separate the pair of rotating members by the separation portion when it is determined that a conveyance failure has occurred in a predetermined region including an image forming region by the ink head based on a detection result of the first sensor, and perform control not to separate the pair of rotating members by the separation portion when it is determined that a conveyance failure has occurred in a region different from the predetermined region based on a detection result of the second sensor.

2. The image forming apparatus according to claim 1, wherein the conveyance path includes a first conveyance branch provided upstream of the ink head in the conveyance direction and closest to the ink head, and a second conveyance branch provided downstream of the ink head in the conveyance direction and closest to the ink head, and
the predetermined region is a region from the first conveyance branch to the second conveyance branch.

3. The image forming apparatus according to claim 2, wherein the first conveyance branch is branched into a conveyance path configured to guide the recording medium to the image forming region and a conveyance path configured to guide the recording medium to an discharge port which discharges the recording medium to the outside.

4. The image forming apparatus according to claim 2, wherein the second conveyance branch branches into a conveyance path configured to guide the recording medium having an image formed on one side to the image forming region again, and a conveyance path configured to guide the recording medium to a downstream unit without guiding the recording medium to the image forming region.

5. The image forming apparatus according to claim 2, wherein the first conveyance member is provided downstream of the first conveyance branch in the conveyance direction and upstream of the ink head.

6. The image forming apparatus according to claim 1, wherein the conveyance portion includes a second conveyance member configured to nip and convey the recording medium by a pair of rotating members capable of abutting against and separating from each other, the second conveyance member being disposed at a position different from a position of the first conveyance member, and
when the controller determines that a conveyance failure has occurred in the predetermined region, the controller performs control so as not to separate the pair of rotating members of the second conveyance member.

7. The image forming apparatus according to claim 6, wherein when the controller determines that a conveyance failure has occurred in the predetermined region, the controller controls the conveyance member to discharge the recording medium remaining on the conveyance path to the outside by the second conveyance member.

8. The image forming apparatus according to claim 1, wherein the conveyance portion includes a conveyance belt configured to convey the recording medium in the predetermined region, and
the first conveyance member is driven and controlled by first hardware, and the conveyance belt is driven and controlled by second hardware capable of more precise control than the first hardware.

9. The image forming apparatus according to claim 1, wherein the controller controls the pair of rotating members to be separated from each other by the separation portion before rotation of a roller included in the pair of rotating members is stopped.
